(19) United States
(12) Patent Application Publication
(10) Pub. No.: US 2020/0259807 A1
(43) Pub. Date: Aug. 13, 2020

(54) VIRTUAL PRIVATE NETWORK (VPN) OFFLOAD FRAMEWORK USING GENERIC COMMANDS

(71) Applicant: QUALCOMM Incorporated, San Diego, CA (US)

(72) Inventors: Abhishek Rastogi, Bangalore (IN); Sourav Poddar, Bangalore (IN); Bhaskar Valaboju, Bangalore (IN); Subhash Kumar Katnapally, Hyderabad (IN); Samarjeet Banerjee, Bangalore (IN)

(21) Appl. No.: 16/537,204

(22) Filed: Aug. 9, 2019

(30) Foreign Application Priority Data
Feb. 12, 2019 (IN) 201941005435

(51) Int. Cl. H04L 29/06; H04L 12/46

(52) U.S. Cl. CPC H04L 63/0485; H04L 63/164; H04L 12/4633; H04L 12/4641; H04L 63/0272

(57) ABSTRACT

This disclosure provides systems, methods and apparatus, including computer programs encoded on computer storage media for encapsulating and decapsulating packets for transmission via virtual private networks (VPNs). In one aspect, a packet is identified for transmission via a specified VPN. An ordered sequence of operations corresponding to the VPN may be received, with a set of parameters corresponding to the ordered sequence of operations. An encapsulated packet may be generated by performing the ordered sequence of operations on the packet using the set of parameters.

### CROSS-REFERENCE TO RELATED APPLICATIONS

This Patent Application claims priority to India Foreign Patent Application No. 201941005435 entitled “VIRTUAL PRIVATE NETWORK (VPN) OFFLOAD FRAMEWORK USING GENERIC COMMANDS” filed on Feb. 12, 2019, which is assigned to the assignee hereof. The disclosure of the prior Application is considered part of and is incorporated by reference in this Patent Application.

### TECHNICAL FIELD

This disclosure relates generally to secure communications, and more specifically to secure communications using virtual private networks (VPNs).

### DESCRIPTION OF THE RELATED TECHNOLOGY

A virtual private network (VPN) is a private network which may extend across one or more public networks such as the Internet. Devices connected to the VPN may securely exchange data with each other using the public network as if the devices were directly connected to each other via a private network. For example, a VPN may allow a remote employee's computer to securely exchange data with an employer's computer system or associated private intranet using the Internet. Many VPNs employ tunneling techniques in which packets selected for transmission are encapsulated with additional fields (such as an additional header, an additional tail, additional padding bytes, sequence numbers, and so on) and then encrypted for transmission across a public network. Encapsulated packets received at a destination may be decrypted and decapsulated to recover the original packet.

Different types of VPNs may perform different sets of operations on packets to be transmitted across a network via the VPN. For example, a VPN using the Internet Protocol (IP) Security (IPSec) protocols may perform different operations on packets to be transmitted than a VPN using the OpenVPN protocols.

### SUMMARY

The systems, methods and devices of this disclosure each have several innovative aspects, no single one of which is solely responsible for the desirable attributes disclosed herein. Aspects of the present disclosure relate to systems and methods for encapsulating or decapsulating packets for transmission or reception across a network via one or more virtual private networks (VPNs). One innovative aspect of the subject matter described in this disclosure can be implemented in a method for wireless communication. The method may include identifying a packet for transmission via a specified VPN, receiving an ordered sequence of operations corresponding to the specified VPN, and receiving a set of parameters corresponding to the ordered sequence of operations. In some implementations, each of the plurality of VPNs may be associated with a corresponding one of the ordered sequence of operations.

The method also may include generating a first encapsulated packet by performing the ordered sequence of operations on the packet using the set of parameters, and providing the first encapsulated packet for transmission via the specified VPN. In some implementations, the first encapsulated packet may be generated without the ordered sequence of operations or the corresponding set of parameters identifying the specified VPN. In addition, or in the alternative, the first encapsulated packet may be generated using a VPN accelerator comprising application-specific hardware and firmware. The VPN accelerator may be configured to decapsulate packets received via a plurality of VPNs, the plurality of VPNs including the specified VPN. The ordered sequence of operations may include one or more of a VPN header addition, a public network header addition, packet encryption, sequence number processing, or a pad addition. The set of parameters may include one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, or an IV offset.

Another innovative aspect of the subject matter described in this disclosure can be implemented in a communications device. In some implementations, the communications device may include a transceiver to exchange communications signals via at least one network, one or more processors, and a memory storing instructions for execution by the one or more processors. Execution of the instructions may cause the communications device to identify a packet for transmission via a specified virtual private network (VPN), receive an ordered sequence of operations corresponding to the specified VPN, receive a set of parameters corresponding to the ordered sequence of operations, generate a first encapsulated packet by performing the ordered sequence of operations on the packet using the set of parameters, and provide the first encapsulated packet for transmission via the specified VPN. In some implementations, each of the plurality of VPNs may be associated with a corresponding one of the ordered sequence of operations.

In some implementations, the first encapsulated packet may be generated without the ordered sequence of operations or the corresponding set of parameters identifying the specified VPN. In addition, or in the alternative, the first encapsulated packet may be generated using a VPN accelerator comprising application-specific hardware and firmware. The VPN accelerator may be configured to decapsulate packets received via a plurality of VPNs, the plurality of VPNs including the specified VPN. The ordered sequence of operations may include one or more of a VPN header addition, a public network header addition, packet encryption, sequence number processing, or a pad addition. The set of parameters may include one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, or an IV offset.

Another innovative aspect of the subject matter described in this disclosure can be implemented as a method for wireless communication. In some implementations, the method may include receiving a first encapsulated packet via the specified VPN, receiving an ordered sequence of operations corresponding to the specified VPN, receiving a set of parameters corresponding to the ordered sequence of operations, and generating a decapsulated packet by performing the ordered sequence of operations on the first encapsulated packet using the set of parameters. In some implementations, the decapsulated packet may be generated without the ordered sequence of operations or the corresponding set of parameters identifying the specified VPN. In addition, or in the alternative, the decapsulated packet may be generated using a VPN accelerator comprising application-specific hardware and firmware. The VPN accelerator may be configured decapsulate packets received via a plurality of VPNs, the plurality of VPNs including the specified VPN. In some implementations, each of the plurality of VPNs may be associated with a corresponding one of the ordered sequence of operations. The ordered sequence of operations may include one or more of VPN header removal, public network header removal, packet decryption, sequence number processing, or pad removal. The set of parameters may include one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, and an IV offset.

In some implementations, the method also may include determining that the decapsulated packet is intended for transmission via a second VPN different from the specified VPN, receiving a second ordered sequence of operations corresponding to the second VPN, receiving a second set of parameters corresponding to the second ordered sequence of operations, generating a second encapsulated packet by performing the second ordered sequence of operations on the decapsulated packet using the second set of parameters, and providing the second encapsulated packet for transmission via the second VPN.

Another innovative aspect of the subject matter described in this disclosure can be implemented in a communications device. In some implementations, the communications device may include a transceiver to exchange communications signals via at least one network, one or more processors, and a memory storing instructions for execution by the one or more processors. Execution of the instructions may cause the communications device to receive a first encapsulated packet via a specified virtual private network (VPN), receive an ordered sequence of operations corresponding to the specified VPN, receive a set of parameters corresponding to the ordered sequence of operations, and generate a decapsulated packet by performing the ordered sequence of operations on the first encapsulated packet using the set of parameters. In some implementations, the decapsulated packet may be generated without the ordered sequence of operations or the corresponding set of parameters identifying the specified VPN. In addition, or in the alternative, the decapsulated packet may be generated using a VPN accelerator comprising application-specific hardware and firmware. The VPN accelerator may be configured decapsulate packets received via a plurality of VPNs, the plurality of VPNs including the specified VPN. In some implementations, each of the plurality of VPNs may be associated with a corresponding one of the ordered sequence of operations. The ordered sequence of operations may include one or more of VPN header removal, public network header removal, packet decryption, sequence number processing, or pad removal. The set of parameters may include one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, and an IV offset.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example communications system.

FIG. 2 shows an example communications device.

FIG. 3 shows an example series of operations which may be performed to encapsulate a packet for transmission via a VPN.

FIG. 4 shows an illustrative flow chart depicting an example operation for encapsulating a packet for transmission via a VPN.

FIG. 5 shows an illustrative flow chart depicting an example operation for decapsulating an encapsulated packet.

FIG. 6 shows an illustrative flow chart depicting an example operation for encapsulating a decapsulated packet for transmission.

Like reference numerals refer to corresponding parts throughout the drawing figures.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving signals according to any of the IEEE 16.11 standards, or any of the IEEE 802.11 standards, or any of the IEEE 802.3 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wired, wireless, cellular or internet of things (IOT) network, such as a system utilizing 3G, 4G or 5G, or further implementations thereof, technology.

Implementations of the subject matter described in this disclosure may support different types of VPNs by considering each VPN encapsulation and decapsulation process as an ordered sequence of operations. The operations may include encryption/decryption operations, authentication/de-authentication operations, L3/L4 header encapsulation and decapsulation operations, VPN header encapsulation and decapsulation operations, anti-replay checks, pad insertion operations, and pad removal operations. In some implementations, a set of ordered parameters associated with the specified VPN may be used in conjunction with the ordered sequence of operations to perform encapsulation and decapsulation operations according to the specified VPN. For implementations in hardware or firmware, the ordered sequence of operations may be provided, for example, as a task array sent by a host operating system to the hardware or firmware. The set of parameters may be provided in an opaque format, and may include specific information pertaining to the VPN including, for example, offsets, session identifiers, and sequence numbers.

Particular implementations of the subject matter described in this disclosure can be implemented to realize one or more of the following potential advantages. Because different types of VPNs may use different operations to encapsulate packets for transmission and may use different operations to decapsulate received packets, a communication device may need to store different software for each VPN (or each type of VPN) to be used for exchanging data with other devices, which may consume limited memory and processing resources of the communication device. The example implementations disclosed herein may allow a communication device to support multiple types of VPNs without duplicative software, hardware, or firmware for each type of VPN, and also may allow new or additional types of VPNs to be supported without requiring development of new software, hardware, or firmware. In some implementations, the communication devices disclosed herein also may support multiple types of VPNs without prior knowledge of any specific VPN type.

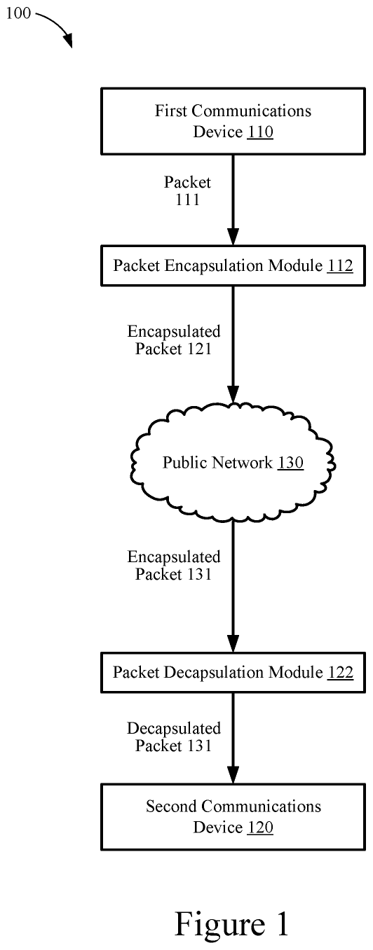

FIG. 1 shows a block diagram of an example communications system 100 within which aspects of the present disclosure may be implemented. The communications system 100 is shown to include a first communication device 110, a public network 130, and a second communication device 120. In some implementations, the first communications device 110 may have a packet 111 for transmission to the second communications device 120 over the public network 130 using a VPN (for simplicity, the VPN is not shown in FIG. 1). The packet 111 may be provided to a packet encapsulation module 112, which may encapsulate and format the packet 111 for transmission across the public network 130, in accordance with one or more parameters the VPN, as an encapsulated packet 131. In some implementations, the encapsulation module 112 may encapsulate one or more VPN headers or tails, one or more pad additions, one or more authentication operations, and one or more encryption operations within the packet 111. The packet encapsulation module 112 also may encapsulate one or more headers corresponding to the public network 130 within the packet 111.

For example, if the public network 130 is the Internet, the one or more headers may include one or more L3/L4 headers (such as TCP/IP headers). In some implementations, the packet encapsulation module 112 may be implemented as software, hardware, firmware, or any combination thereof in a router or server device that is separate from the first communications device 110. In other implementations, the packet encapsulation module 112 may be implemented as software, hardware, or firmware as a part of the first communications device 110. The encapsulated packet 121 may be transmitted to the second communication device 120 via the public network 130.

The packet decapsulation module 122 may receive the encapsulated packet 121 via the public network 130, and may decapsulate the packet 121 by performing a sequence of operations on the encapsulated packet 121, for example, to reverse the operations performed on the packet 111 by the packet encapsulation module 112. The sequence of operations may include the removal of one or more VPN headers or tails, one or more pad removals, one or more de-authentication operations, one or more decryption operations, and so on. In some implementations, the packet decapsulation module 122 also may remove the one or more headers corresponding to the public network 130. The decapsulated packet 131, which may be identical (or at least substantially identical) to the “original” packet 111, may be provided to the second communications device 120. In some implementations, the packet decapsulation module 122 may be implemented as software, hardware, or firmware in a router or server device that is separate from the second communications device 120. In other implementations, the packet decapsulation module 122 may be implemented as software, hardware, or firmware in the second communications device 120.

In some other implementations, the packet encapsulation module 112 and the packet decapsulation module 122 may be implemented as a VPN accelerator including hardware and firmware configured to perform the encapsulation and decapsulation operations corresponding to the VPN. In some implementations, the VPN accelerator may be part of or associated with a network device (such as a router).

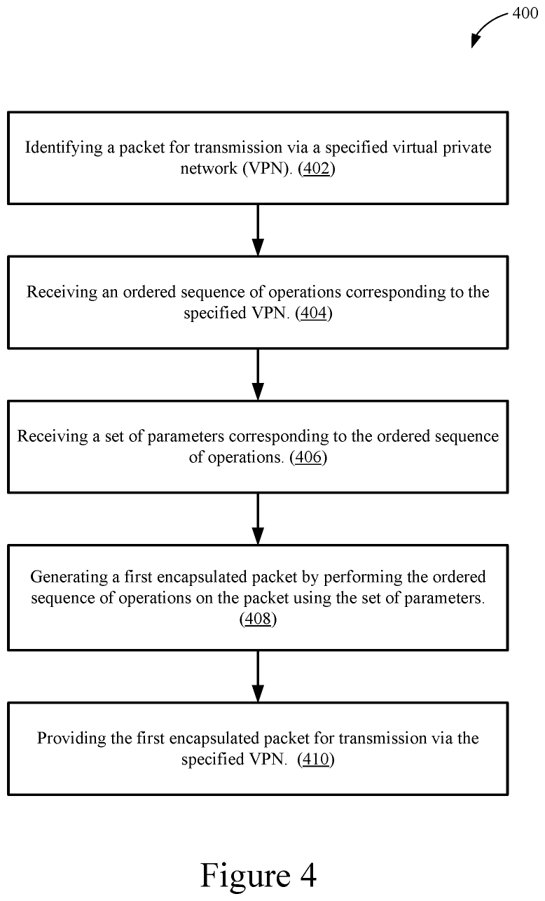

In some implementations, each of the first communications device 110 and the second communications device 120 may include one or more transceivers, one or more processing resources (such as processors, ASICs, or a combination of both), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described with respect to FIGS. 4-6.

Each of the first communications device 110 and the second communications device 120 may be any suitable Wi-Fi enabled wireless device including, for example, a cell phone, personal digital assistant (PDA), tablet device, laptop computer, wireless station (STA), wireless access point (AP), or the like. For implementations in which the first communications device 110 and the second communications device 120 are STAs, each of the first communications device 110 and the second communications device 120 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

For implementations in which the first communications device 110 and the second communications device 120 are access points (APs), the first communications device 110 and the second communications device 120 may be any suitable device that allows one or more wireless devices to connect to a network (for example, a local area network (LAN), wide area network (WAN), metropolitan area network (MAN), or the Internet) using Wi-Fi, Bluetooth, or any other suitable wireless communication standards.

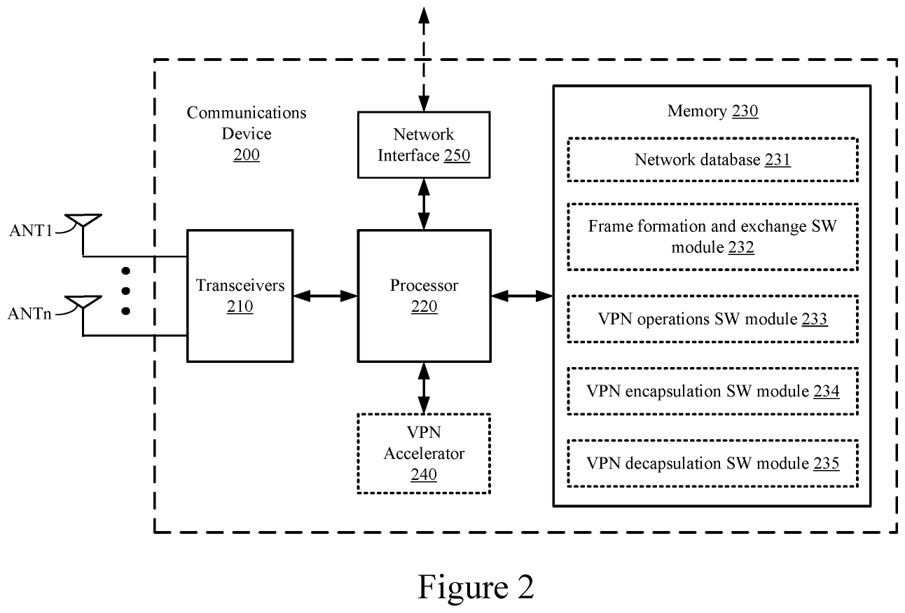

FIG. 2 shows an example communications device 200. The communications device 200, which may be one example of the first communications device 110 or the second communications device 120 of FIG. 1, may be any suitable wireless communication device including (but not limited to) wireless stations (STAs) and access points (APs). The communications device 200 may include one or more transceivers 210, a processor 220, a memory 230, and a number of antennas ANT1-ANTn. The transceivers 210 may be coupled to the antennas ANT1-ANTn, either directly or through an antenna selection circuit (not shown for simplicity). The transceivers 210 may be used to transmit signals to and receive signals from other wireless devices including, for example, one or more of the first communications device 110 or the second communications device 120 of FIG. 1. Although not shown in FIG. 2 for simplicity, the transceivers 210 may include any number of transmit chains to process and transmit signals to other wireless devices via the antennas ANT1-ANTn, and may include any number of receive chains to process signals received from the antennas ANT1-ANTn. Thus, the communication device 200 may be configured for MIMO communications and OFDMA communications. The MIMO communications may include SU-MIMO communications and MU-MIMO communications. In some implementations, the communication device 200 may use multiple antennas ANT1-ANTn to provide antenna diversity. Antenna diversity may include polarization diversity, pattern diversity, and spatial diversity.

For implementations in which the communication device 200 is or operates as an AP, the communication device 200 may include a network interface 250 coupled to at least the processor 220. The network interface 250 may allow the communication device 200 to communicate, either directly or via one or more intervening networks, with other wireless systems, with other APs, with one or more back-haul networks, or any combination thereof.

The communications device 200 also may include a VPN accelerator 240, or optionally, the VPN accelerator 240 may be external and coupled to the communications device 200. The VPN accelerator 240 may be a network device that can provide perform operations and tasks relating to VPN encapsulation and decapsulation. In some implementations, the VPN accelerator 240 may include application-specific hardware and firmware for performing such operations and tasks. For example, the VPN accelerator 240 may contain components including (but not limited to) specialized processors, field-programmable gate arrays (FPGAs), application-specific integrated circuits (ASICs), and so on.

The memory 230 may include a network database 231 to store location data, configuration information, data rates, addresses, and other suitable information for a number of networks, access points, stations, or any combination thereof. The profile information for a particular AP may include information including, for example, the AP's SSID, MAC address, channel information, RSSI values, goodput values, channel state information (CSI), supported data rates, connection history with the AP, a trustworthiness value of the AP (such as indicating a level of confidence about the AP's location, etc.), and any other suitable information pertaining to or describing the operation of the AP.

The memory 230 also may include a non-transitory computer-readable medium (for example, one or more nonvolatile memory elements, such as EPROM, EEPROM, Flash memory, a hard drive, and so on) that may store at least the following software (SW) modules:
a frame formatting and exchange software module 232 to facilitate the creation and exchange of any suitable frames (such as data frames, action frames, and management frames) between the communications device 200 and other devices;
a VPN operations SW module 233 to store one or more sequences of operations for encapsulating and decapsulating packets according to one or more different types of VPNs;
a VPN encapsulation SW module 234 to generate a sequence of operations for packet encapsulation based on a specified type of VPN; and
a VPN decapsulation SW module 235 to generate a sequence of operations for packet decapsulation based on a specified type of VPN.
   Each software module includes instructions that, when executed by processor 220, cause the communications device 200 to perform the corresponding functions. The non-transitory computer-readable medium of the memory 230 thus includes instructions for performing all or a portion of the operations described with respect to FIGS. 4-6.

The processor 220, which is shown in the example of FIG. 2 as coupled to transceiver 210, to the memory 230, and to the VPN accelerator 240, may be any suitable one or more processors capable of executing scripts or instructions of one or more software programs stored in the communications device 200 (for example within memory 230). The processor 220 may execute the frame formatting and exchange software module 232 to facilitate the creation and exchange of any suitable frames (such as data frames, action frames, and management frames) between the communications device 200 and other devices.

The processor 220 may execute the VPN operations SW module 233 to store one or more sequences of operations for encapsulating and decapsulating packets according to one or more different types of VPNs. The processor 220 may execute the VPN encapsulation SW module 234 to generate sequences of encapsulation operations and corresponding parameters. The processor 220 may execute the VPN decapsulation SW module 235 to generate a sequence of operations for packet decapsulation based on a specified type of VPN. The generated sequences of encapsulation operations and decapsulation operations may be used by the processor 220 or the VPN accelerator 240 (or both) to encapsulate packets and decapsulate packets, respectively, in a manner compliant with the VPN (or type of VPN) to be used for transmitting the packets across a network (such as the public network of FIG. 1).

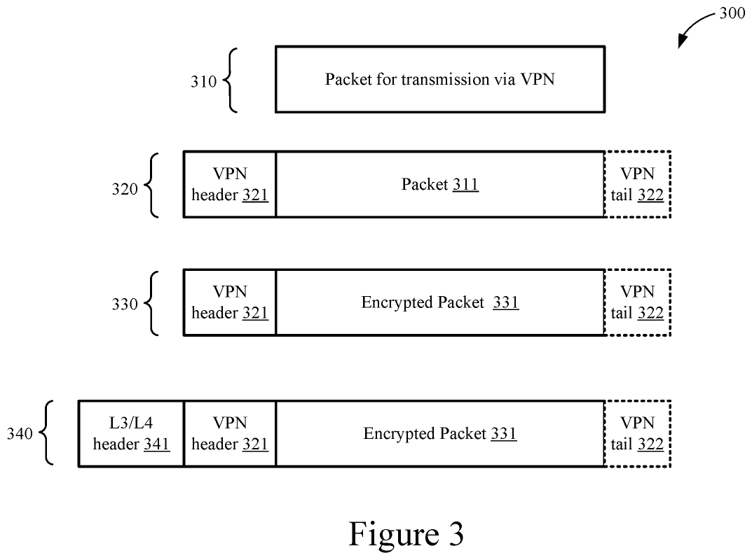

FIG. 3 shows an example series of operations 300 which may be performed to encapsulate a packet for transmission via a VPN. Note that the operations shown in FIG. 3 are merely illustrative, and that different types of VPNs may require differing sequences of operations to be performed for encapsulation of packets for transmission. During a first stage 310, a packet 311 may be provided for transmission from a source device to a destination device via a VPN. During a second stage 320, one or more VPN headers 321 may be pre-pended to the packet 311, and in some implementations, one or more VPN tails 322 may be appended to the end of the packet 311.

During a third stage 330, one or more encryption operations may be performed to encrypt the packet 311. In some implementations, portions of the VPN header 321 or portions of the VPN tail 322 (or both) also may be encrypted, for example, depending upon the type or characteristics of the VPN. In other implementations, the VPN header 321 and the VPN tail 322 may be sent in plaintext, for example, depending upon the type or characteristics of the VPN.

Although not shown in FIG. 3 for simplicity, one or both of the second stage 320 and the third stage 330 may include additional operations relating to the transmission of packets (such as the packet 311) through the VPN. These additional operations may include (but are not limited to) padding operations, keyed-hash message authentication (HMAC) operations, cipher initiation vector (IV) operations, adding one or more sets of padding bytes to one or more of the VPN header 321, the VPN tail 322, the packet 311, or the encrypted packet 331; one or more keyed-hash message authentication (HMAC) operations may be performed, setting an HMAC value to a proper value; and one or more cipher initiation vector (IV) operations may be performed setting IV to a proper value.

During a fourth stage 340, an L3/L4 header (TCP/IP header) 341 may be pre-pended to the VPN header 321. In some other implementations, other suitable headers may be pre-pended to the encrypted packet 331, for example, based on one or more characteristics of the public network over which the VPN is established. Thus, after performing the sequence of operations shown in FIG. 3, the packet 311 is encapsulated and formatted for transmission via the VPN.

As discussed, different types of VPN may use different sequences of operations for encapsulating packets for transmission, and also may use different sequences of operations for decapsulating received packets. Conventional devices may need to store a different set of encapsulation operations and a different set of decapsulation operations for each type of VPN that may be used to transmit data across a network (such as the Internet), which may consume limited memory and processing resources, as well as potentially risking license encumbrances in hardware or firmware. The example communication devices disclosed herein may support multiple different types of VPNs by providing a set of generic operations (denoted herein as “VPN primitives”) that can be combined or supplemented with a corresponding set of parameters when encapsulating packets to be transmitted via the specified VPN and when decapsulating packets received from the specified VPN. In this manner, the communication device may store a single set of generic operations and a plurality of sets of parameters, for example, rather than a plurality of different sets of operations. In some implementations, each set of parameters may be tailored or otherwise configured for a corresponding one of a plurality of different VPNs or types of VPNs.

In some implementations, a packet may be encapsulated for transmission via a particular VPN type may be expressed as an ordered sequence of such operations, combined with a corresponding set of parameters. Thus, rather than requiring separate software, hardware, and firmware for each VPN type, a single solution may support multiple VPN types. Moreover, for implementations including hardware and firmware, such hardware and firmware may not require knowledge of any specific supported VPN, but instead only how to perform the set of VPN primitives.

In some implementations, the set of VPN primitives may include a VPN header addition; a VPN header removal; a public network header addition (such as an L3/L4 header for TCP/IP); a public network header removal; packet encryption; packet decryption; sequence number processing, or “anti-replay”; pad addition; and pad removal. Note that the specific action to be performed for each of these VPN primitives may differ based on the type of VPN. Thus, the corresponding set of parameters may account for these differences. For example, the VPN header addition primitive may correspond to one or more parameters specifying how the VPN header should be added and its contents, and the encryption primitive may correspond to one or more parameters indicating which portions of the packet should be encrypted (for example whether only the payload should be encrypted, or whether portions of the header should be as well) and the type of encryption to be used. Similarly, the pad addition VPN primitive may correspond to one or more parameters indicating where the pad should be added and its size. In some implementations this corresponding set of parameters may be provided in an opaque format, such as a blob format.

For some VPN types, some parameters may change per packet. For example, in some VPN types, such dynamic parameters may include sequence numbers, session identifiers, and so on. In some implementations, the set of parameters may include one or more offsets to indicate a difference between a previous packet's value of a dynamic parameter and the current packet's value. This may allow determination of these dynamic parameters without providing the hardware or firmware with knowledge of the specific VPN type used.

In some implementations, the corresponding set of parameters may include a number of parameters in a known order. For example, the corresponding set of parameters may include parameters such as: a session id offset; a session id size; a VPN header head size; a VPN header head offset; a VPN header tail size; a VPN header tail offset; a sequence number size; a sequence number offset; a cipher offset; an authentication offset; a hashed message authentication code (HMAC) size; an HMAC offset; a cipher initiation vector (IV) size; and an IV offset.

Thus, each encapsulation and decapsulation operation may be represented as a task array indicating a sequence of such VPN primitives, and the blob or other opaquely-formatted corresponding set of parameters. Thus, the task array and corresponding parameters may be provided to the VPN accelerator without the VPN accelerator being tailored to any particular VPN type.

As an example, and without limitation, some implementations may support encapsulation and decapsulation of packets for transmission via VPNs that employ the IPSec protocol. For such an example, the task array may include five operations: VPN header addition; VPN tail addition; a first encryption and authentication operation; a second encryption and authentication operation; and an L3/L4 header addition operation. Each operation may be performed using corresponding values in the set of parameters. For example, the VPN addition operation may use at least a sequence identifier offset parameter, a sequence number parameter, and an IV offset parameter. Similarly, the first encryption and authentication operation may use at least an encryption algorithm type, one or more encryption keys, an authentication algorithm type, and one or more authentication keys. Further, the second encryption and authentication may use at least an HMAC offset parameter.

In addition, or in the alternative, an example VPN accelerator may be configured to bridge a first VPN and a second VPN, where the first VPN is a different type than the second VPN. For example, the VPN accelerator may receive a VPN packet from a first VPN type. Upon receiving a first task array and corresponding first set of parameters, the VPN accelerator may decapsulate the received packet. The VPN accelerator may then receive a second task array and corresponding second set of parameters, corresponding to the second VPN. The VPN accelerator may then encapsulate the packet for transmission via the second VPN.

FIG. 4 shows an illustrative flow chart depicting an example operation 400 for encapsulating a packet for transmission via a VPN. The operation 400 may be performed by any suitable wireless communication device including the communications devices 110 and 120 of FIG. 1 or the communications device 200 of FIG. 2. The operation 400 may begin with identifying a packet for transmission via a specified virtual private network (VPN). In some implementations, the packet may be received from another communications device, for example via a local network. Alternatively, the packet may be generated internally to the communications device.

The operation 400 may proceed with receiving an ordered sequence of operations corresponding to the specified VPN (404). In some implementations, the ordered sequence of operations may be a task array including a sequence of operations for encapsulating the packet for transmission via the specified VPN.

The operation 400 may proceed with receiving a set of parameters corresponding to the ordered sequence of operations (406). In some implementations, the set of parameters may be received in an opaque file format, such as a binary large object (blob) format. The set of parameters may include a plurality of parameters, each parameter of the plurality of parameters corresponding to an operation in the sequence of operations.

The operation 400 may proceed with generating a first encapsulated packet by performing the ordered sequence of operations on the packet using the set of parameters (408). According to some implementations, the first encapsulated packet may be generated without the ordered sequence of operations or the corresponding set of parameters identifying the specified VPN. In some aspects, the first encapsulated packet may be generated using application-specific hardware, such as using a VPN accelerator 240.

The operation 400 may proceed with providing the first encapsulated packet for transmission via the specified VPN (410).

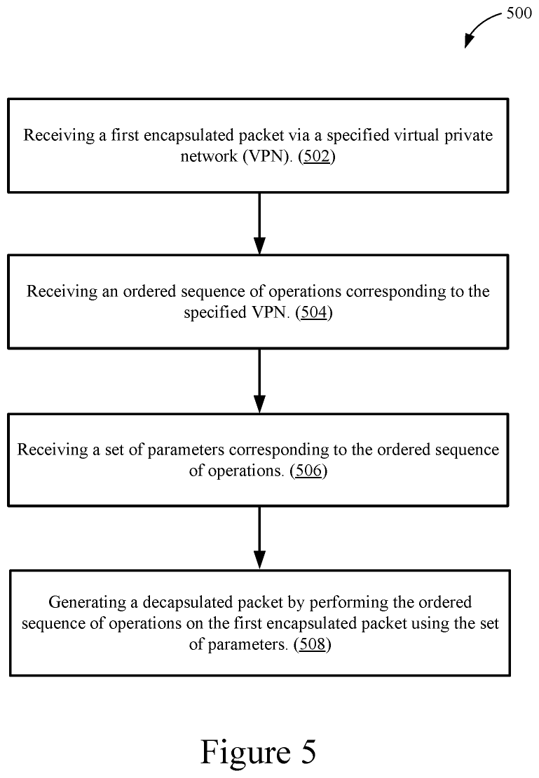

FIG. 5 shows an illustrative flow chart depicting an example operation 500 for decapsulating an encapsulated packet. The operation 500 may be performed by any suitable wireless communication device including the communications devices 110 and 120 of FIG. 1 or the communications device 200 of FIG. 2. The operation 500 may begin with receiving a first encapsulated packet via a specified virtual private network (VPN) (502).

The operation 500 may proceed with receiving an ordered sequence of operations corresponding to the specified VPN (504). In some implementations, the ordered sequence of operations may be a task array including a sequence of operations for encapsulating the packet for transmission via the specified VPN.

The operation 500 may proceed with receiving a set of parameters corresponding to the ordered sequence of operations (506). In some implementations, the set of parameters may be received in an opaque file format, such as a binary large object (blob) format. The set of parameters may include a plurality of parameters, each parameter of the plurality of parameters corresponding to an operation in the sequence of operations.

The operation 500 may proceed with generating a decapsulated packet by performing the ordered sequence of operations on the first encapsulated packet using the set of parameters (508). In some implementations, the decapsulated packet may be generated without the ordered sequence of operations or the corresponding set of parameters identifying the specified VPN. In some aspects, the decapsulated packet may be generated using application-specific hardware, such as using a VPN accelerator 240.

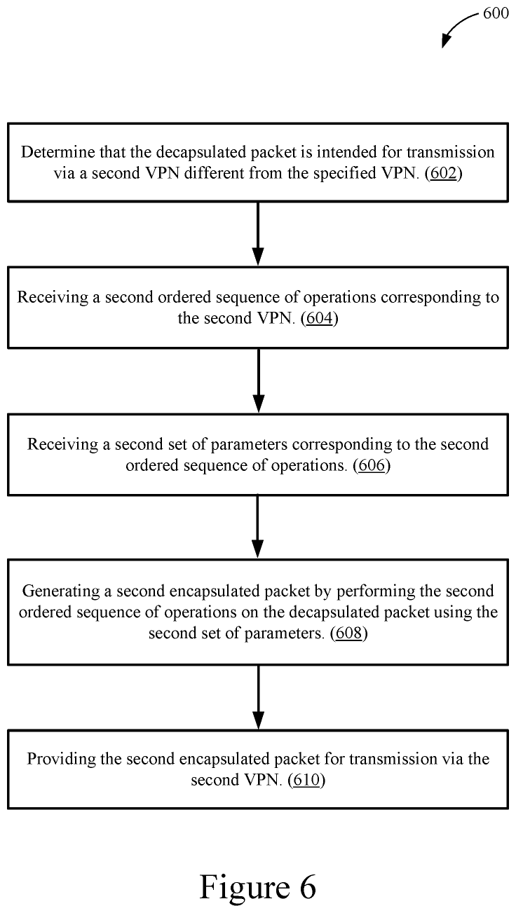

FIG. 6 shows an illustrative flow chart depicting an example operation 600 for encapsulating a decapsulated packet for transmission. The operation 600 may be performed by any suitable wireless communication device including the communications devices 110 and 120 of FIG. 1 or the communications device 200 of FIG. 2. In some implementations, the operation 600 may begin after completion of the operation 500 described with respect to FIG. 5 with determining that the decapsulated packet is intended for transmission via a second VPN different from the specified VPN (602).

The operation 600 may proceed with receiving a second ordered sequence of operations corresponding to the second VPN (604). In some implementations, the ordered sequence of operations may be a task array including a sequence of operations for encapsulating the packet for transmission via the specified VPN.

The operation 600 may proceed with receiving a second set of parameters corresponding to the second ordered sequence of operations (606). In some implementations, the set of parameters may be received in an opaque file format, such as a binary large object (blob) format. The set of parameters may include a plurality of parameters, each parameter of the plurality of parameters corresponding to an operation in the sequence of operations.

The operation 600 may proceed with generating a second encapsulated packet by performing the second ordered sequence of operations on the decapsulated packet using the second set of parameters (608). In some implementations, the decapsulated packet may be generated without the ordered sequence of operations or the corresponding set of parameters identifying the specified VPN. In some aspects, the decapsulated packet may be generated using application-specific hardware, such as using a VPN accelerator 240.

The operation 600 may proceed with providing the second encapsulated packet for transmission via the second VPN (610).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communication, comprising:
identifying a packet for transmission via a specified virtual private network (VPN);
receiving an ordered sequence of operations corresponding to the specified VPN;
receiving a set of parameters corresponding to the ordered sequence of operations;
generating a first encapsulated packet by performing the ordered sequence of operations on the packet using the set of parameters; and
providing the first encapsulated packet for transmission via the specified VPN.

2. The method of claim 1, wherein the first encapsulated packet is generated without the ordered sequence of operations or the corresponding set of parameters identifying the specified VPN.

3. The method of claim 1, wherein a communications device performs the method by executing one or more instructions stored in a non-transitory computer-readable storage medium.

4. The method of claim 1, wherein the first encapsulated packet is generated using a VPN accelerator comprising application-specific hardware and firmware.

5. The method of claim 4, wherein the VPN accelerator is configured to decapsulate packets received via a plurality of VPNs, the plurality of VPNs including the specified VPN.

6. The method of claim 5, wherein each of the plurality of VPNs is associated with a corresponding one of the ordered sequence of operations.

7. The method of claim 1, wherein the ordered sequence of operations includes one or more of a VPN header addition, a public network header addition, packet encryption, sequence number processing, or a pad addition.

8. The method of claim 1, wherein the set of parameters includes one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, or an IV offset.

9. A method for wireless communication, comprising:
receiving a first encapsulated packet via a specified virtual private network (VPN);
receiving an ordered sequence of operations corresponding to the specified VPN;
receiving a set of parameters corresponding to the ordered sequence of operations; and
generating a decapsulated packet by performing the ordered sequence of operations on the first encapsulated packet using the set of parameters.

10. The method of claim 9, wherein the decapsulated packet is generated without the ordered sequence of operations or the corresponding set of parameters identifying the specified VPN.

11. The method of claim 9, wherein a communications device performs the method by executing one or more instructions stored in a non-transitory computer-readable storage medium.

12. The method of claim 9, wherein the decapsulated packet is generated using a VPN accelerator comprising application-specific hardware and firmware.

13. The method of claim 12, wherein the VPN accelerator is configured to decapsulate packets received via a plurality of VPNs, the plurality of VPNs including the specified VPN.

14. The method of claim 13, wherein each of the plurality of VPNs is associated with a corresponding one of the ordered sequence of operations.

15. The method of claim 9, wherein the ordered sequence of operations includes one or more of a VPN header removal, a public network header removal, packet decryption, sequence number processing, or a pad removal.

16. The method of claim 9, wherein the set of parameters includes one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, or an IV offset.

17. The method of claim 9, further comprising:
determining that the decapsulated packet is intended for transmission via a second VPN different from the specified VPN;
receiving a second ordered sequence of operations corresponding to the second VPN;
receiving a second set of parameters corresponding to the second ordered sequence of operations;
generating a second encapsulated packet by performing the second ordered sequence of operations on the decapsulated packet using the second set of parameters; and
providing the second encapsulated packet for transmission via the second VPN.

18. A communications device, comprising:
a transceiver to exchange wireless signals via at least one network;
one or more processors; and
a memory storing instructions that, when executed by the one or more processors, cause the communications device to:
identify a packet for transmission via a specified virtual private network (VPN);
receive an ordered sequence of operations corresponding to the specified VPN;
receive a set of parameters corresponding to the ordered sequence of operations;
generate a first encapsulated packet by performing the ordered sequence of operations on the packet using the set of parameters; and
provide the first encapsulated packet for transmission via the specified VPN.

19. The communications device of claim 18, wherein the first encapsulated packet is generated without the ordered sequence of operations or the corresponding set of parameters identifying the specified VPN.

20. The communications device of claim 18, wherein the first encapsulated packet is generated using a VPN accelerator comprising application-specific hardware and firmware.

21. The communications device of claim 18, wherein the communications device is configured to encapsulate packets for transmission via each of a plurality of VPNs, the plurality of VPNs including the specified VPN.

22. The communications device of claim 21, wherein each of the plurality of VPNs is associated with a corresponding ordered sequence of operations for encapsulating packets for transmission.

23. The communications device of claim 18, wherein the ordered sequence of operations includes one or more of a VPN header addition, a public network header addition, packet encryption, sequence number processing, or a pad addition.

24. A communications device, comprising:
a transceiver to exchange wireless signals via at least one network;
one or more processors; and
a memory storing instructions that, when executed by the one or more processors, cause the communications device to:
receive a first encapsulated packet via a specified virtual private network (VPN);
receive an ordered sequence of operations corresponding to the specified VPN;
receive a set of parameters corresponding to the ordered sequence of operations; and
generate a decapsulated packet by performing the ordered sequence of operations on the first encapsulated packet using the set of parameters.

25. The communications device of claim 24, wherein the decapsulated packet is generated without the ordered sequence of operations or the corresponding set of parameters identifying the specified VPN.

26. The communications device of claim 24, wherein the decapsulated packet is generated using a VPN accelerator comprising application-specific hardware and firmware.

27. The communications device of claim 24, wherein the communications device is configured to decapsulate packets received via a plurality of VPNs, the plurality of VPNs including the specified VPN.

28. The communications device of claim 27, wherein each of the plurality of VPNs is associated with a corresponding ordered sequence of operations.

29. The communications device of claim 27, wherein the ordered sequence of operations includes one or more of a VPN header removal, a public network header removal, packet decryption, sequence number processing, or a pad removal.

30. The communications device of claim 27, wherein the set of parameters includes one or more of a session identifier (ID) offset, a session ID size, a VPN header head size, a VPN header head offset, a VPN header tail size, a VPN header tail offset, a sequence number size, a sequence number offset, a cipher offset, an authentication offset, a hashed message authentication code (HMAC) size, an HMAC offset, a cipher initiation vector (IV) size, or an IV offset.
